(19) United States
(12) Patent Application Publication
(10) Pub. No.: US 2018/0059026 A1
(43) Pub. Date: Mar. 1, 2018

(54) Surface Enhanced Raman Spectroscopy (SERS) Structure For Double Resonance Output

(71) Applicant: Optokey, Inc., Hayward, CA (US)

(72) Inventors: Jian Ye, Shanghai (CN); Fanqing Frank Chen, Moraga, CA (US); Robert P. Chebi, San Carlos, CA (US)

(21) Appl. No.: 15/682,398

(22) Filed: Aug. 21, 2017

Related U.S. Application Data
(60) Provisional application No. 62/378,575, filed on Aug. 23, 2016.

(51) Int. Cl. G01N 21/65; G01N 21/552

(52) U.S. Cl. CPC G01N 21/658; G01N 21/554

(57) ABSTRACT

A Raman spectroscopy structure includes a substrate, a conductive layer formed on the substrate, a dielectric layer formed on the conductive layer, wherein the dielectric layer has a first thickness, and spaced apart conductive structures formed on the dielectric layer having a periodicity. Each of the conductive structures has a second thickness and a shape that defines a localized surface plasmonic resonance (LSPR) frequency mode having a width. The dielectric layer defines two Fabry-Perot frequency modes that overlap within the width of the LSPR frequency mode. A desirable double resonance is achieved by two frequency Fabry-Perot modes overlapping within the width of a single frequency plasmonic mode.

### RELATED APPLICATIONS

This application claims the benefit of U.S. Provisional Application No. 62/378,575, filed Aug. 23, 2016, and which is incorporated herein by reference.

### FIELD OF THE INVENTION

The present invention relates to Surface Enhanced Roman Spectroscopy (SERS) for characterizing molecular properties.

### BACKGROUND OF THE INVENTION

Raman spectroscopy is a fingerprint spectrum technique that discloses vibrational information of molecules. Plasmonic resonance occurs when an exciting electromagnetic wave interacts with the metallic nano structures, which significantly amplifies the Raman signal of the molecule adsorbed on the nanostructures' surface and shows high sensitivity. This is called surface enhanced Raman spectroscopy (SERS). The detection technologies based on SERS are fast techniques, with easy sample preparation, and is nondestructive and effective. Recently, taking advantage of the development of the micro-nano fabrication technology, a SERS substrate with sophisticated tiny structures is possible. At present, SERS exhibits significant potential application in variant fields, like environmental monitoring, crime investigation, forensic analysis, food security, disease diagnosis, quality control, identification of artworks and cultural relics, etc.

For biomolecule detection and biological application based on SERS, a laser light source in a near infrared wavelength (like 785 nm) is generally chosen in order to reduce the impact on the biological sample and the disturbance of background fluorescence. Near infrared laser light shows better penetration depth in blood and human tissue. Thus, near infrared SERS is more suitable for applications in biological samples and in vivo molecular detection and imaging. However, the Raman signal excited by near infrared laser light is much weaker since the Raman spectrum intensity (I) and source frequency (ω) are proportional at the fourth power (I∝ω⁴). What's more, SERS is one of the most typical applications of plasmonic materials which, based on the electromagnetic enhancement mechanism, is strongly dependent on the localized electric field of the plasmonic materials. The enhance factor (EF) is determined by electric field enhancement in excitation (EFₑₓ) and scattering (EF_{scat}) wavelengths: EF=|EFₑₓ|²|EF_{scat}|², which is approximated to EF=|EFₑₓ|² when excitation and scattering wavelengths are close. The separation between these wavelengths are more than 100 nm when near infrared laser light is applied, which significantly reduces the effectiveness of the amplification property of the single resonance SERS substrate. For this, double resonance surface enhanced Raman spectroscopy has been proposed by Kenneth Crozier in Harvard University, where the designed plasmonic material possesses double resonances. Both of the resonances match the excitation and scattering wavelengths respectively so that the localized electric field is enlarged under both wavelengths, which produces an EF reaching ˜10⁹. However, such double resonance plasmonic materials are generally realized by nanostructures or particles with tiny gaps (like dimer) (Banaee M G, Crozier K B, ACS Nano, 2011, 5, 307.). This is a big challenge to fabrication, as it increases cost and decreases reproducibility.

### BRIEF SUMMARY OF THE INVENTION

A spectroscopy structure, comprising a substrate, a conductive layer formed on the substrate, a dielectric layer formed on the conductive layer, wherein the dielectric layer has a first thickness, and spaced apart conductive structures formed on the dielectric layer having a periodicity. Each of the conductive structures has a second thickness and a shape that defines a localized surface plasmonic resonance (LSPR) frequency mode having a width. The dielectric layer defines two Fabry-Perot frequency modes that overlap within the width of the LSPR frequency mode.

Other objects and features of the present invention will become apparent by a review of the specification, claims and appended figures.

### BRIEF DESCRIPTION OF THE DRAWINGS

FIG. 1 is a cross sectional view of a SERS structure.

FIG. 2A is a perspective view of a SERS sandwich structure.

FIG. 2B is a graph illustrating simulated reflection spectrum for the structure of FIG. 2A.

FIG. 2C is an electronic field distribution map for the structure of FIG. 2A.

FIG. 3A is a perspective view of a SERS nano-ring structure.

FIG. 3B is a graph illustrating simulated reflection spectrum for the structure of FIG. 3A.

FIG. 3C is an electronic field distribution map for the structure of FIG. 3A.

FIG. 4A is a perspective view of a SERS nano-ring structure.

FIG. 4B is a graph illustrating simulated reflection spectrum for the structure of FIG. 4A.

FIG. 4C is an electronic field distribution map for the structure of FIG. 4A.

FIG. 5A is a perspective view of a SERS nano-ring structure.

FIG. 5B is a simulated reflection spectrum for the structure of FIG. 5A as the thickness of the dielectric layer is varied.

FIG. 6 is a simulated reflection spectra showing the relation between double resonance and dielectric layer's thickness when the thickness is varied.

FIG. 7 is a simulated reflection spectra showing the tuning of the double resonance by varying an inner diameter of a gold nano ring SERS structure.

FIG. 8 is a simulated reflection spectra showing the tuning of the double resonance by varying a periodicity of a gold nano ring SERS structure.

FIG. 9A illustrates a triangular ring SERS structure and its simulated reflection spectrum.

FIG. 9B illustrates a quadrangular ring SERS structure and its simulated reflection spectrum.

FIG. 9C illustrates a pentagonal ring SERS structure and its simulated reflection spectrum.

FIG. 10 is the scanning electron microscopic image of the SERS substrate in Example 1.

FIG. 11 is the reflection spectrum of the SERS structure in Example 1.

FIG. 12 is the scanning electron microscopic image of the SERS substrate in Example 4.

FIG. 13 is the reflection spectrum of the SERS structure in Example 4.

FIG. 14 is the scanning electron microscopic image of the SERS substrate in Example 5.

FIG. 15 is the reflection spectrum of the SERS structure in Example 5.

FIG. 16A is a perspective view of a Fabry-Perot cavity.

FIG. 16B is the simulated reflectance spectra of the Fabry-Perot cavity of FIG. 16A.

FIG. 16C is a perspective view of a Fabry-Perot cavity.

FIG. 16D is the simulated reflectance spectra of the Fabry-Perot cavity of FIG. 16C.

FIG. 16E is a perspective view of a Fabry-Perot cavity.

FIG. 16F is the simulated reflectance spectra of the Fabry-Perot cavity of FIG. 16E.

FIG. 17 is the simulated optical spectra for Example 4.

FIG. 18 is the reflection spectral map of gold cavities.

FIG. 19A is a top view of another SERS structure.

FIG. 19B is a side cross sectional view of the SERS structure of FIG. 19A.

FIG. 20A illustrates simulated reflection spectra showing the relation between double resonance and variations in diameter and period for the structure of FIGS. 19A and 19B.

FIG. 20B illustrates simulated double resonances for the structure of FIGS. 19A and 19B of different dimensions.

FIG. 21 is a side cross sectional view of another SERS structure.

FIG. 22A illustrates simulated reflection spectra showing the relation between double resonance and variations in cavity length for the structure of FIG. 21.

FIG. 22B illustrates simulated double resonances for the structure of FIG. 21 of different dimensions.

FIG. 23A illustrates simulated reflection spectra showing the relation between double resonance and variations in dielectric layer for the structure of FIG. 21.

FIG. 23B illustrates simulated double resonances for the structure of FIG. 21 of different dimensions.

FIG. 24A illustrates simulated reflection spectra showing the relation between double resonance and variations in cavity length for the structure of FIG. 21.

FIG. 24B illustrates simulated double resonances for the structure of FIG. 21 of different dimensions.

FIG. 25 is a schematic diagram for a system implementing the present invention.

### DETAILED DESCRIPTION OF THE INVENTION

The present invention is a double resonance SERS structure designed with a new strategy, which exhibits a strong and reproducible Raman spectroscopy signal. Generally speaking, a Fabry Perot cavity (i.e., a sandwich structure of metal-dielectric-metal) produces several resonances with different cavity mode orders. However, the electric field enhancement is not localized so that the enhancement effect is not evident and is confined in the dielectric layer (between both of the metallic layers) so that biological molecules cannot approach this region. With this defect, this structure is not ideal for SERS. A single nanostructure or nanostructure array can produce single localized surface plasmonic resonance (LSPR), which can enhance infrared SERS, but weakly. The coupling of LSPR and cavity mode produces a double resonance effect, which increases EF significantly (highly sensitive) in infrared wavelengths. Unlike the coupling of the nano dimers which strongly depends on horizontal tiny gaps, the coupling of this structure only relies on the vertical coupling between the LSPR and cavity mode, so that the tiny nanostructures have been effectively avoided which increases the uniformity of the chip and the signal repeatability and reduces the requirement and cost of the chip's fabrication process.

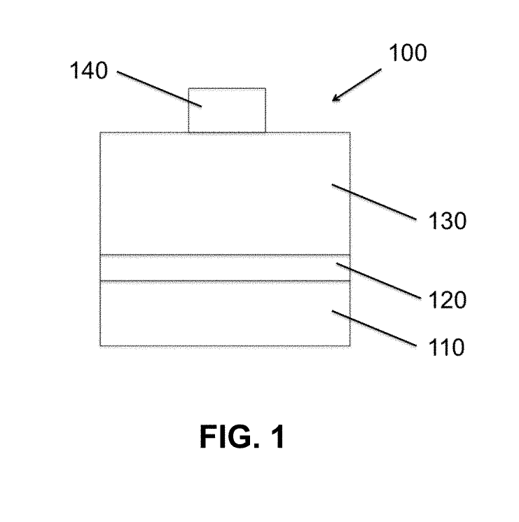

As shown in FIG. 1, the present invention provides a SERS structure 100 that includes a substrate 110, a metallic layer 120 on the substrate 110, a dielectric layer 130 on the metallic layer 120, and a metallic nano-array structure 140 on the dielectric layer 130. The thickness of the dielectric layer 130 given the materials involved can result in an overlap of the frequency plasmonic mode (dictated by the nano-array structure above the cavity) with the frequency Fabry-Perot mode of the cavity itself. More specifically, when two frequency Fabry-Perot modes overlap within the width of a single frequency plasmonic mode, then a desirable double resonance can be achieved.

Substrate 110 can be formed of one or more of the following materials: metal, polymeric material, glass, silicon, silica, alumina and quartz. Metallic layer 120 can be formed of one or more of the following materials: gold, silver, copper, aluminum, platinum, nickel, sodium, potassium lithium, titanium, chromium, cadmium, palladium and gallium. Preferably, metallic layer 120 is a continuous layer, having a thickness of approximately 10 nm to 200 nm. The dielectric layer 130 can be formed of one or more of the following materials: silica, glass, quartz, Al₂O₃, polymer and Si₃N₄. Preferably, dielectric layer 130 is a continuous layer. The nano-array structure 140 can be formed of one or more of the following materials: gold, silver, copper, aluminum, platinum, nickel, sodium, potassium, lithium, titanium, chromium, cadmium, palladium and gallium. Preferably, the array of nano-array structures 140 has a thickness of approximately 2 nm to 200 nm, and includes a plurality of spaced apart nano-structures 140 preferably having one or more of the following shapes: spheres, round disks, triangular disks, quadrangular disks, rods (cylinder), round rings, triangular rings, quadrangular rings and pentagonal rings.

The structure composed of the metallic layer 120, the dielectric layer 130 and the metallic nano-array structure 140 exhibits double plasmonic resonance by the coupling of the LSPR and cavity modes of the Fabry-Perot cavity. Further, strong electric field amplifications are achieved at both of the resonant wavelengths. The double resonant wavelengths can be controllably tuned by modifying the material and thickness of the dielectric layer 130, and the configuration parameters of the metallic nano-array structures 140 such as dimensions, diameter, shape, periodicity, etc.

### Simulation

The finite difference time domain (FDTD) method is applied herein to explore the coupling principle between the localized surface plasmonics and Fabry-Perot cavities, the double plasmonic resonance produced by the structure and the electric field enhancement and tunability of the double resonance.

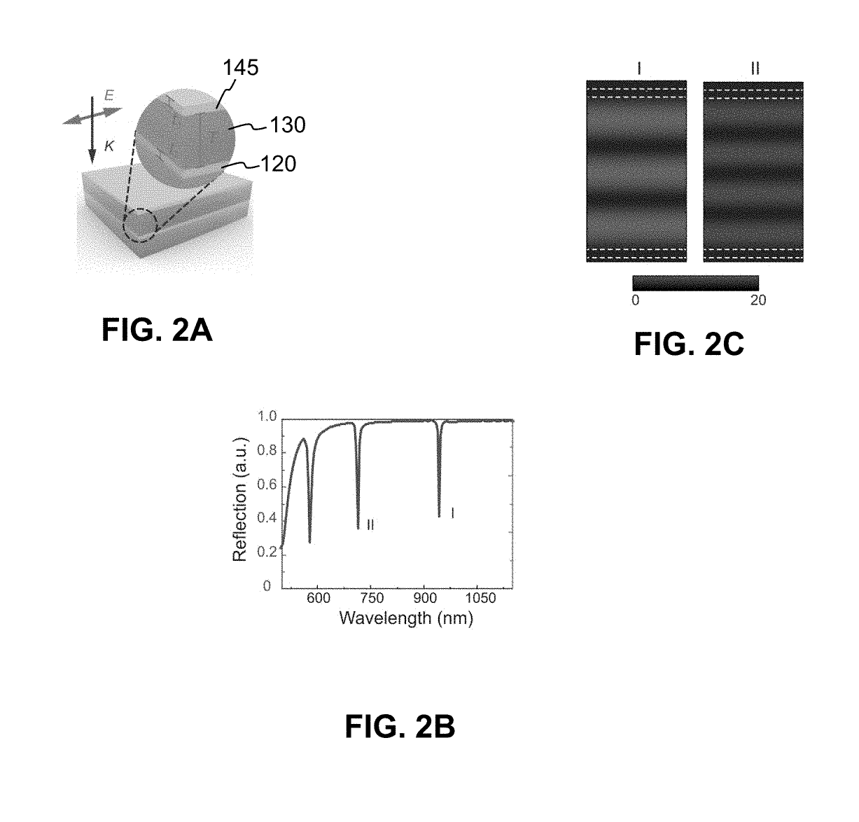

FIG. 2A illustrates a sandwich SERS structure of two gold films 120 and 145 separated by a silica dielectric layer 130. In the sandwich structure of FIG. 2A, the bottom gold film 120 is 50 nm in thickness t₁, the top gold film 145 is 50 nm in thickness t₂, and the silica layer 130 is 925 nm in thickness T. This structure presents cavity modes at both wavelengths of 700 nm and 950 nm, as shown in FIG. 2B. However, the enhanced electric field at both resonant wavelengths is weak, whose maximum value of both resonance is 5 and 3, respectively, as shown in FIG. 2C. In addition, the electric field enhancement is confined in the dielectric layer 130, between both of the metallic layers 120 and 145, where biological molecules cannot approach, and therefore the maximum enhancement on the top surface is only 0.8. With these defects, this structure is not ideal for optimizing SERS.

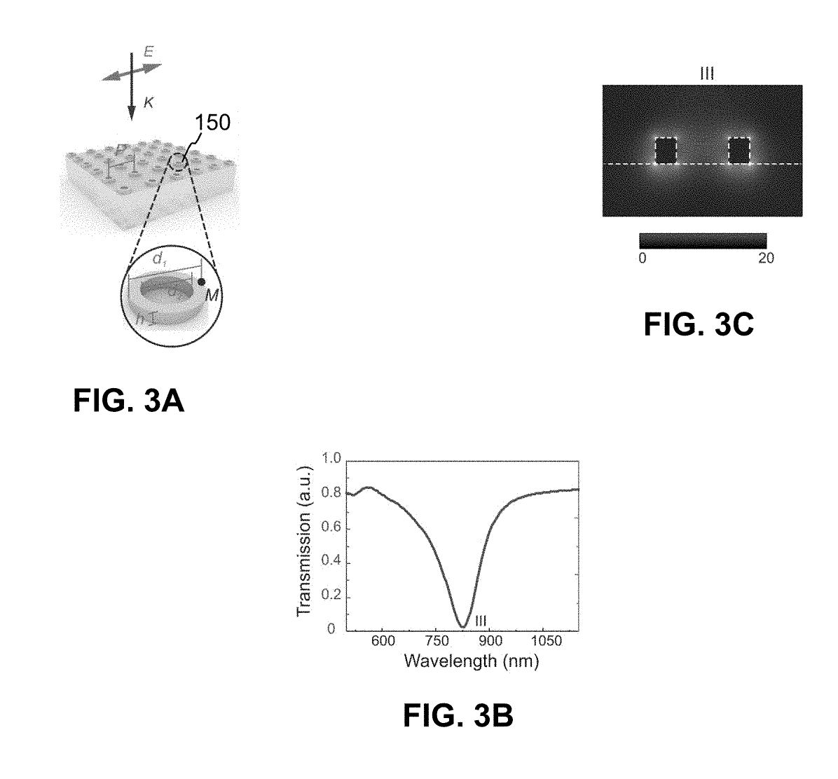

FIG. 3A illustrates a gold nano-ring array where the top film is configured in the shape of spaced apart rings 150. The rings 150 have a thickness/height h of 50 nm, an external diameter d₁ of 180 nm, an internal diameter d₂, and a periodicity P (spacing between centers of adjacent rings) of 380 nm. This structure exhibits a plasmonic resonance at 820 nm, as shown in FIG. 3B. At this resonant wavelength, the electric field enhancement is confined around the ring, and the value recorded at point M is 8, as shown in FIG. 3C. A double resonance SERS based on a double resonance plasmonic substrate is not possible for this nano ring array with a single plasmonic resonance.

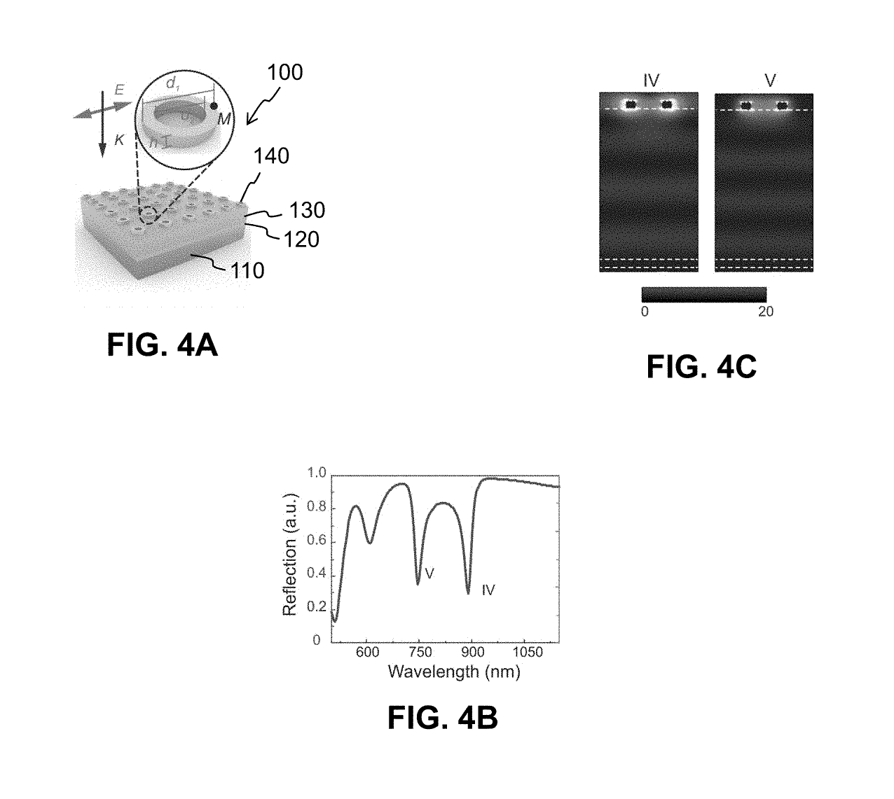

FIG. 4A illustrates a SERS structure 100 which is similar to that of FIG. 2A, which includes SERS substrate 110, gold layer 120 with thickness of 50 nm, and silica dielectric layer 130 with a thickness of 925 nm. This embodiment includes an array of spaced apart round gold rings 140 with the thickness of 50 nm. The spaced apart gold round rings 140 each have an external diameter d₁ of 180 nm and an inner diameter d₂ of 100 nm, and the array has a periodicity P (spacing between centers of adjacent rings) of 380 nm. This configuration presents asymmetric double resonances at 750 nm and 890 nm, as shown in FIG. 4B, through the coupling between the gold nano-ring array, only one resonance, and the cavity mode. The electric field enhancements are 27 and 12 at both of the resonant wavelengths recorded at point M (see FIGS. 4A and 4C), which are much larger than that of the structures in FIGS. 2A and 3A. Moreover, the electric field enhancement is mainly confined around the nano-ring, which is ideal for SERS. The double resonance's wavelengths can be tuned by modifying the dielectric layer's thickness and the nano-array's size, periodicity, shape, aspect ratio, and so on.

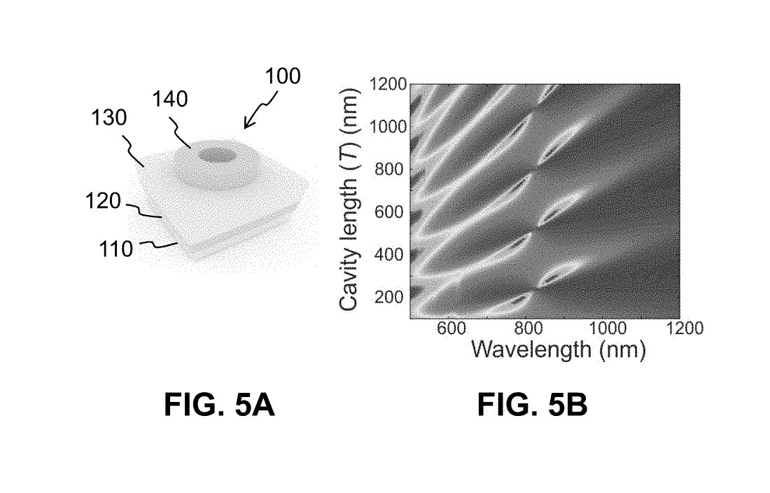

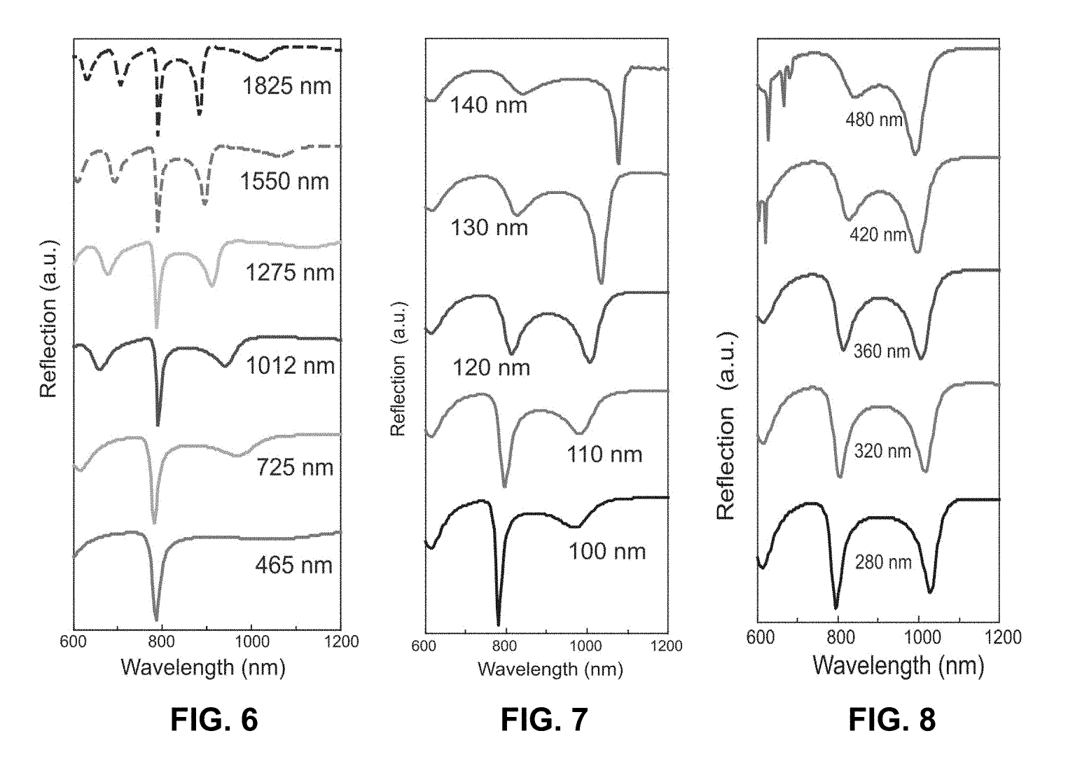

FIG. 5A better illustrates one of the nano-rings 140 of the SERS structure 100 of FIG. 4A. Tunability of the double resonance is achieved by varying the thickness of the dielectric silica layer 130 in the range of 100 nm to 1200 nm, as shown in FIG. 5B. The spectra in FIG. 6 shows the controllable tunability of the double resonances when the thickness of the dielectric silica layer 130 is varied. Further simulation shows that the tunability is possible when the silica dielectric thickness in the range of 2 μm to 10 μm. The spectra in FIG. 7 shows the tunability of the double resonance by varying the gold round ring array's inner diameter d₂ in the range of 100 nm to 140 nm (with a silica dielectric layer 130 thickness of 725 nm). The spectra in FIG. 8 shows the tunability of the double resonance by varying the gold round ring array's periodicity in the range of 280 nm to 480 nm (with a silica dielectric layer 130 thickness of 725 nm, an external diameter d₁ of 180 nm, and an inner diameter d₂ of 120 nm).

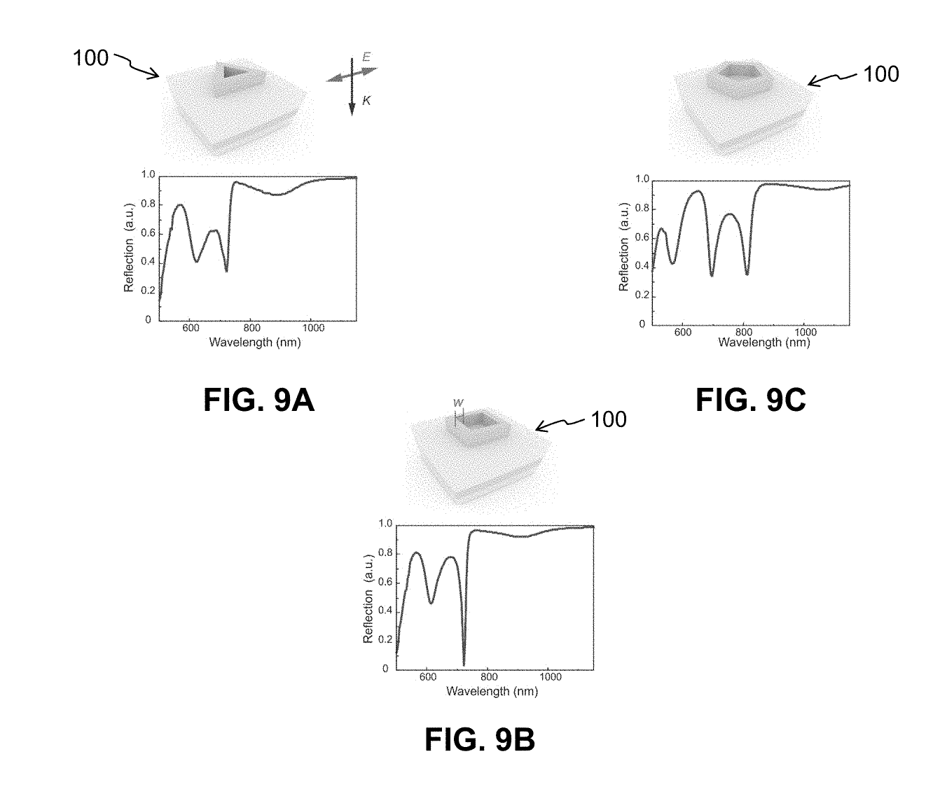

FIGS. 9A-9C illustrate the tunability of the double resonance by varying the shape of the upper film array of structures 140 with shapes such as regular triangular rings, quadrangular rings and pentagonal rings. Specifically, FIG. 9A-9C show the triangular, quadrangular and pentagonal ring structure, respectively, of upper film array of structures 140, and their respective reflection spectra. The spectra are based upon the gold layer 120 having a 50 nm thickness, the silica dielectric layer 130 having a 785 nm thickness (triangular and quadrangular ring) or 850 nm thickness (pentagonal ring), and the array of gold round ring structures 140 having a 50 nm thickness, an external diameter of 180 nm, and a wall wideness W (i.e. thickness) of 40 nm.

### Experimental Results

The present invention provides a SERS structure in which the thickness and material of the dielectric layer 130 is in the range of 100 nm to 10 μm and provides for double resonance. The SERS structure 100 provides a double resonance effect, which is achieved by the coupling of the localized surface plasmonic resonance (LSPR) and the cavity mode, which exhibits a significant Raman signal enhancement factor (highly sensitive). Meanwhile, tiny nanostructures have been effectively avoided which increases the uniformity of the chip and the signal repeatability and reduces the complexity and cost of the chip's fabrication process. The following are non-limiting examples of materials and configurations for the SERS structure.

Substrate 110 can be any substrate known in the field. Substrate 110 can be made of metal, polymer, glass, silicon, silica, alumina and quartz. Preferable materials of glass include high silica glass, high alumina-containing glass, glass-ceramics, conductive tin-doped indium oxide (ITO) glass and quartz glass. Preferred materials of silicon include monocrystalline silicon and polycrystalline silicon.

Metallic layer 120 may be composed of one or more of the following metallic materials: gold, silver, copper, aluminum, platinum, nickel, sodium, potassium lithium, titanium, chromium, cadmium, palladium and gallium. More preferable metallic materials are one or more of the following metals: gold, silver, copper and aluminum. The most preferable metallic materials are one or more of the following metals: gold, silver and aluminum, and the most preferable metallic material is gold.

Metallic layer 120 is a continual metallic film, with a preferred thickness in the range of 10 nm to 200 nm. A more preferable thickness is in the range of 15 nm to 100 nm, an even more preferable thickness is in the range of 20 nm to 70 nm, and the most preferable thickness is in the range of 30 nm to 50 nm. Preferable fabrication processes include thermal vapor deposition, plasma sputtering and magnetron sputtering, with the more preferable fabrication process being magnetron sputtering.

The metallic layer 120 can be directly coated onto the substrate 110, or a silane coupling agent or metal can be used as an adhesion layer on the substrate 110. A preferable silane coupling agent is trimethoxysilylpropanethiol. Other adhesion layer materials can include Cr and/or Ti, with Ti being most preferable. The metallic adhesion layer can have a thickness of 1-10 nm, more preferably 1-5 nm, and most preferably 1-2 nm. The adhesion layer can be formed by thermal vapor deposition, plasma sputtering and magnetron sputtering (most preferable).

Dielectric layer 130 can be formed of one or more of the following materials: silica, glass, quartz, alumina, polymer, silicon nitride; the more preferable materials include silica, alumina and polymer; the most preferable material is silica. Dielectric layer 130 is preferably a continual dielectric film formed by chemical vapor deposition, plasma sputtering, spin coating and atomic layer deposition, with the more preferable fabrication process being plasma sputtering. Preferably, dielectric layer 130 is coated directly on metallic layer 120 when the dielectric layer is a continual film.

Metallic nano-array of structures 140 is preferably formed of one or more of the following metals: gold, silver, copper, aluminum, platinum, nickel, sodium, potassium lithium, titanium, chromium, cadmium, palladium and gallium; with the more preferable materials being gold, silver, copper and aluminum; and even more preferably materials being gold, silver and aluminum; and the most preferable material being gold. Nano array of structures 140 includes one or more of the following shapes: spheres, round disks, triangular disks, quadrangular disks, rods, round rings, triangular rings, quadrangular rings, pentagonal rings; with the more preferable shapes being spheres, round disks, and round rings; and the most preferable shape being round rings.

Each of the structures 140 have a preferred outer diameter of 4-1000 nm, more preferably 20-800 nm, even more preferably 50-400 nm, and most preferably 100-300 nm. Preferably, the structures 140 are formed by e-beam lithography, photolithography, colloidal lithography and self-assembled method; with the most preferable being e-beam lithography.

The nano array structures 140 can be formed directly on dielectric layer 130, or a coupling agent such as silane or metal can be used as an adhesion layer. Preferably the silane coupling agent is trimethoxysilylpropanethiol. Preferred metallic adhesion layers can be Cr, Ti or the mixture of them and the preferable material is Ti. The metallic adhesion layer's preferable thickness is 1-10 nm, more preferable 1-5 nm, and most preferably 1-2 nm. Preferable fabrication processes for the adhesion layer include thermal vapor deposition, plasma sputtering and magnetron sputtering; more preferably magnetron sputtering.

The SERS structure 100 is ideal for detecting the following molecules: 4-aminothiophenol, 4-mercapto benzoic acid (4-MBA), 1,4-benzenedithiol (P-BDT) and 4-methylthio thiophenol, but can detect many others as well. The SERS structure 100 can be used to detect the following toxic substances: Rhodamine B, Rhodamine 6G, capsanthin, methylene blue, Sudan red I, Sudan red II, Sudan red III, Sudan red IV, trinitrotoluene (TNT), Thiram, sodium diethyldithiocarbamate, dichlorphenoxyacetic acid, imidacloprid, chlorpyrifos, melamine, and dichlorvos (DDVP).

The detection methods of the SERS structure 100 are convenient. The sample can be added by directly dropping a solution sample on the SERS structure 100, or immersing the structure 100 in the solution sample for a certain time. The Raman signal, excited by a laser, is detected when the solution is dried.

The following are specific non-limiting examples of fabricating the SERS structure 100 that produces double resonances.

### Example 1

Step 1: Immerse conductive tin-doped indium oxide (ITO) glass for 5 minutes in acetone (45±2° C.), isopropyl alcohol (60±2° C.) and deionized water in sequence, and dry it with nitrogen gas.
Step 2: Coat 1 nm Ti as a metallic adhesion layer on the conductive tin-doped indium oxide (ITO) glass by vacuum magnetron sputtering.
Step 3: Coat 50 nm gold film on the adhesion layer by vacuum magnetron sputtering.
Step 4: Coat 1250 nm silica film on the gold film by vacuum plasma sputtering.
Step 5: Fabricate the round nano-array structures with the thickness of 30 nm, the diameter of 140 nm, the periodicity of 200 nm, on the silica layer by e-beam lithography.

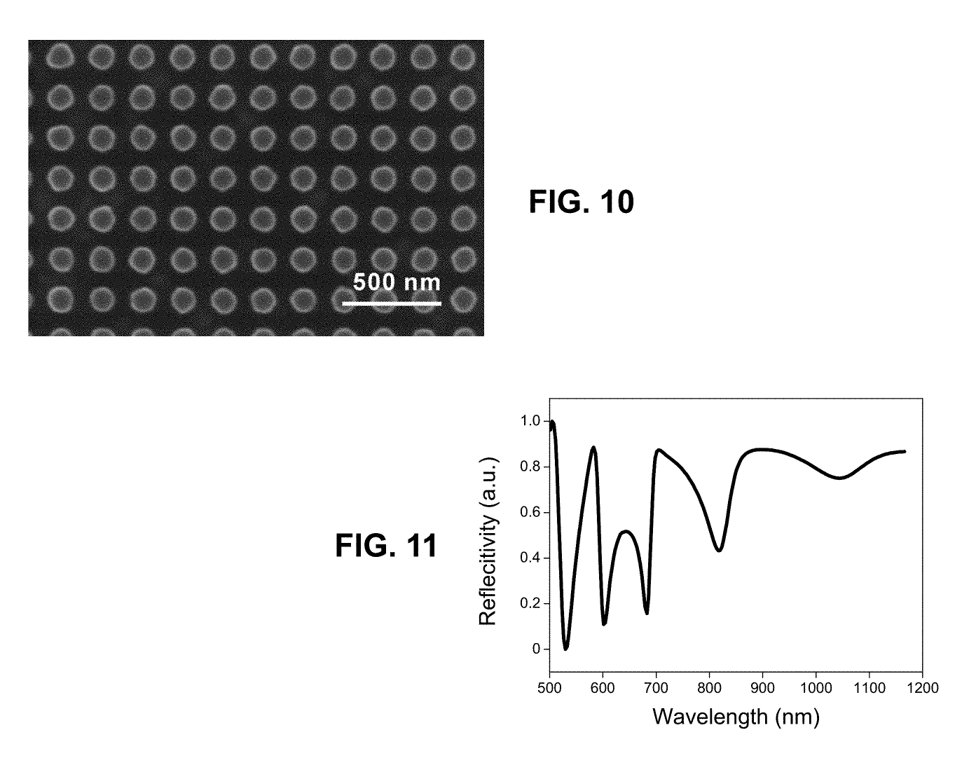

FIG. 10 is the scanning electron microscopic image of the SERS substrate in example 1. The gold round nano-array of structures 140 has the thickness of 30 nm, the diameter of 140 nm, and the periodicity of 200 nm. FIG. 11 is the reflection spectrum of the SERS substrate in example 1. There are double asymmetric resonances at 600 nm and 690 nm.

### Example 2

Step 1: Immerse conductive tin-doped indium oxide (ITO) glass for 5 minutes in acetone (45±2° C.), isopropyl alcohol (60±2° C.) and deionized water in sequence, and dry it with nitrogen gas.
Step 2: Coat 1 nm Ti as a metallic adhesion layer on the conductive tin-doped indium oxide (ITO) glass by vacuum magnetron sputtering.
Step 3: Coat 50 nm gold film on the adhesion layer by vacuum magnetron sputtering.
Step 4: Coating 750 nm silica film on the gold film by vacuum plasma sputtering.
Step 5: Fabricate the round nano array structures with the thickness of 30 nm, the diameter of 140 nm, the periodicity of 200 nm, on the silica layer by e-beam lithography.

### Example 3

Step 1: Immerse conductive tin-doped indium oxide (ITO) glass for 5 minutes in acetone (45±2° C.), isopropyl alcohol (60±2° C.) and deionized water in sequence, and dry it with nitrogen gas.
Step 2: Coat 1 nm Ti as a metallic adhesion layer on the conductive tin-doped indium oxide (ITO) glass by vacuum magnetron sputtering.
Step 3: Coat 50 nm gold film on the adhesion layer by vacuum magnetron sputtering.
Step 4: Coat 450 nm silica film on the gold film by vacuum plasma sputtering.
Step 5: Fabricate the round nano array structures with the thickness of 30 nm, the diameter of 140 nm, the periodicity of 200 nm, on the silica layer by e-beam lithography.

### Example 4

Step 1: Immerse conductive tin-doped indium oxide (ITO) glass for 5 minutes in acetone (45±2° C.), isopropyl alcohol (60±2° C.) and deionized water in sequence, and dry it with nitrogen gas.
Step 2: Coat 1 nm Ti as a metallic adhesion layer on the conductive tin-doped indium oxide (ITO) glass by vacuum magnetron sputtering.
Step 3: Coat 50 nm gold film on the adhesion layer by vacuum magnetron sputtering.
Step 4: Coat 1250 nm silica film on the gold film by vacuum plasma sputtering.
Step 5: Fabricate the round nano-array structures with the thickness of 30 nm, the external diameter of 140 nm, the inner diameter of 40 nm and the periodicity of 200 nm, on the silica layer by e-beam lithography.

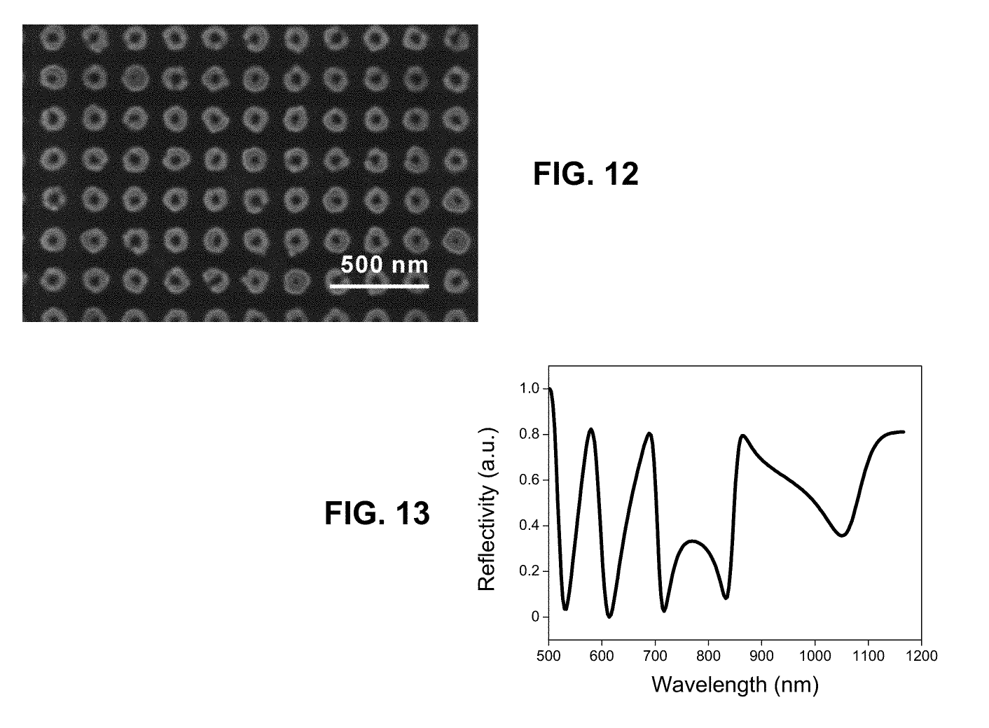

FIG. 12 is the scanning electron microscopic image of the SERS substrate in example 4. The gold nano-ring array structures 140 have the thickness of 30 nm, the external diameter of 140 nm, the inner diameter of 40 nm and the periodicity of 200 nm. FIG. 13 is the reflection spectrum of the SERS substrate in example 4. There are double asymmetric resonances at 710 nm and 830 nm.

### Example 5

Step 1: Immerse conductive tin-doped indium oxide (ITO) glass for 5 minutes in acetone (45±2° C.), isopropyl alcohol (60±2° C.) and deionized water in sequence, and dry it with nitrogen gas.
Step 2: Coat 1 nm Ti as an adhesion layer on the conductive tin-doped indium oxide (ITO) glass by vacuum magnetron sputtering.
Step 3: Coat 50 nm gold film on the adhesion layer by vacuum magnetron sputtering.
Step 4: Coat 1250 nm silica film on the gold film by vacuum plasma sputtering.
Step 5: Fabricate the round nano-array structures with the thickness of 30 nm, the external diameter of 155 nm, the inner diameter of 80 nm and the periodicity of 200 nm, on the silica layer by e-beam lithography.

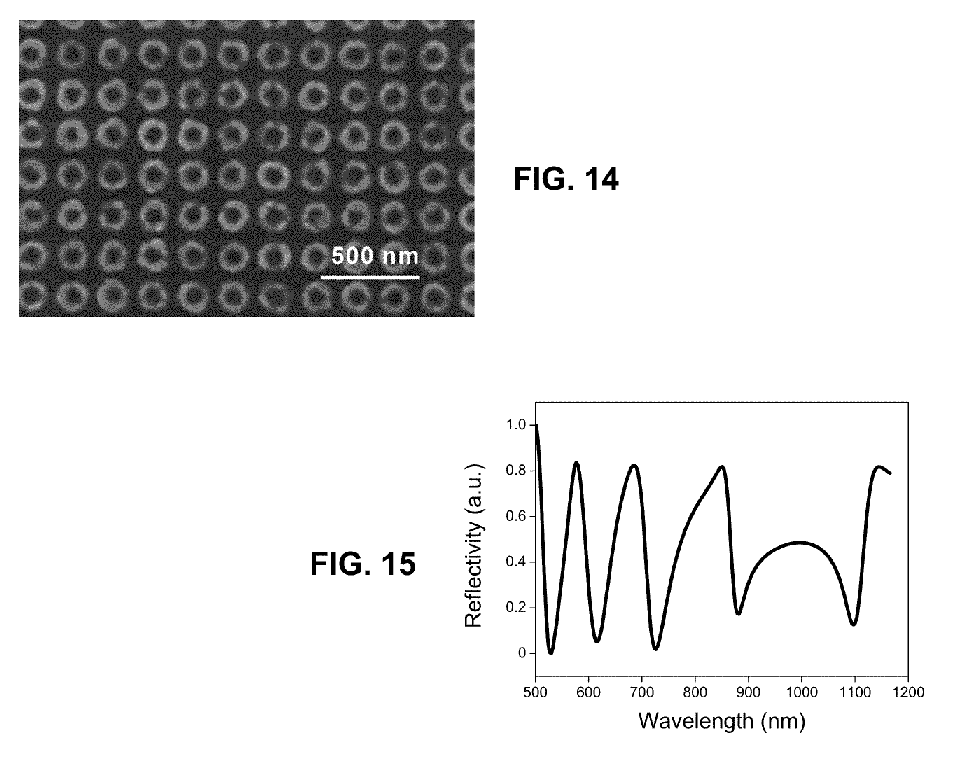

FIG. 14 is the scanning electron microscopic image of the SERS substrate in example 5. The gold nano-ring array structures have the thickness of 30 nm, the external diameter of 155 nm, the inner diameter of 80 nm and the periodicity of 200 nm. FIG. 15 is the reflection spectrum of the SERS substrate in example 5. There are double asymmetric resonances at 890 nm and 1100 nm.

### Double-Resonance Substrate is Beneficial to SERS

The electromagnetic enhancement dominates as a prevailing SERS mechanism in contrast to the chemical one. The enhancement factor (EF) is therefore mainly determined by electric field enhancement at excitation (EFex) and scattering (EF_{scat}) wavelengths: EF=|EFex|²|EFscat|², which is approximated to EF=|EFex|⁴ when excitation and scattering wavelengths are close. The separation between excitation and scattering wavelengths are more than 100 nm when near infrared laser light is applied, which significantly reduces the amplification property of the SERS structure with a single resonance. For this, double-resonance SERS structures have been developed, where the designed plasmonic material possesses double resonances to match the excitation and scattering wavelengths respectively so that the localized electric field is enlarged under both wavelengths resulting in a larger EF than single-resonance SERS structures. Double-resonance SERS structures also offer the ability to selectively amplify Raman spectral bands.

The design process to determine the structures with double resonances is now explained. The following steps provide a determination of whether a SERS structure will provide double resonances.
a) Define the nanostructure array of structures on the top layer and run a numerical simulation with a finite difference time domain (FDTD) program to determine its resonance wavelength and width of localized surface plasmon resonance (LSPR) mode. One example of a FDTD program is the 3D/2D Maxwell's solver for nanophotonic devices, provided by Lumerical Solutions, Inc., of Vancouver, Canada (www.lumerical.com). Nanophotonics related to how light in the wavelength band from 300 nm to approximately 2000 nm interacts with structures at a sub-wavelength scale. At these geometries, photons are confined within the nanoscale structures and the resulting electromagnetic field confined within the structure can be defined by solving the boundary conditions of Maxwell's equations. Computational methods for accurately solving Maxwell's equations for arbitrary 3D geometries such as the Finite Difference Time Domain method combined with computer aided design and analysis provide a powerful platform for research and development in nanophotonics. Lumerical's FDTD Solutions is a 3D Maxwell solver, capable of analyzing the interaction of UV, visible, and IR radiation with complicated structures employing wavelength scale features. The Lumerical Solutions FDTD program is specifically applicable for SERS. Other FDTD programs could be used.
b) According to LSPR's wavelength and width above, a cavity length is then defined by the Fabry-Perot cavity using the FDTD program or roughly following the formula:

λ=2nT/N (1)
where λ is the resonance wavelength of the cavity mode, n is the real part of the refractive index of the dielectric layer in the cavity (roughly can be considered as 1.6 for silica with the length addition due to the reflection phase at metal surface), T is the cavity length, N is the order of the cavity mode, in order to meet the condition that its two neighboring cavity modes spontaneously overlap with the LSPR mode. Formula 1 is a good approximation of the following formula for two parallel flat reflective surfaces:

λ=2nT Cos θ/N (2)
where θ is the deviation angle of the incident EM light.
c) Cavity lengths of such Fabry-Perot cavities are applied to construct the double resonance substrates. The double resonance substrate inherits the configurations of the Fabry-Perot cavity, except that the top metallic film is replaced by the nano-array structures 140.
d) After the simulation works, the configuration parameters of the double resonance substrate with expected properties are determined and are feasible to fabricate the substrate through e-beam lithography accordingly.

The following examples illustrate the design process.

### Example 1

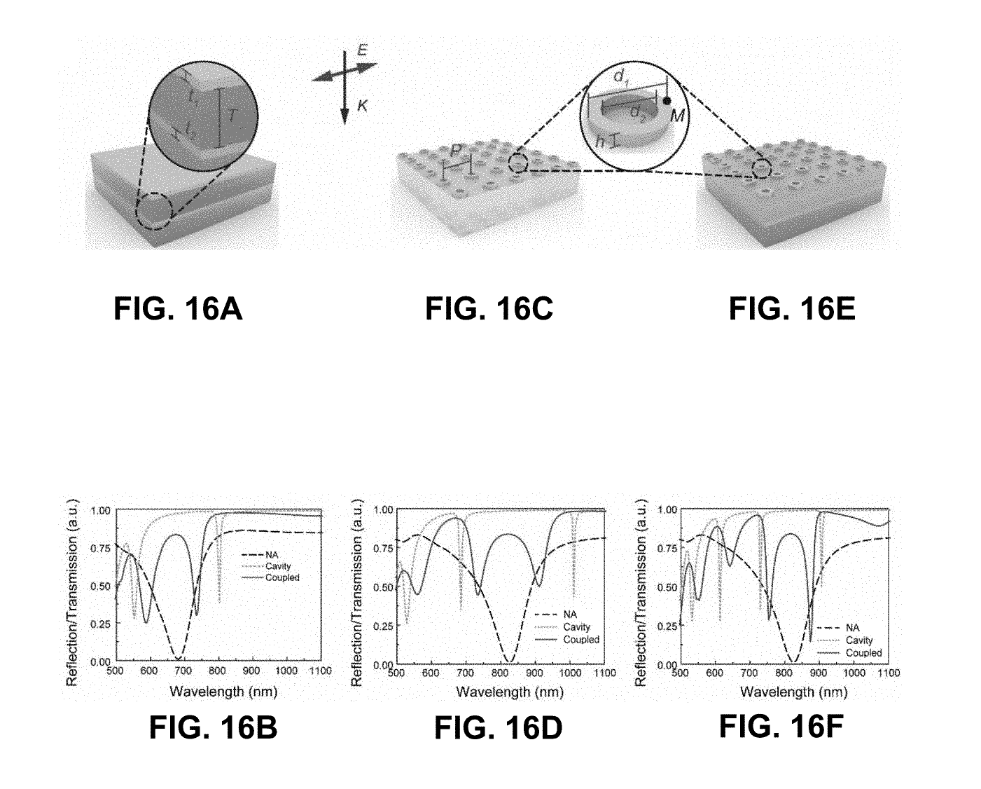

a) First, simulate the LSPR mode of the nano disk array (d₁=180 nm, d₂=0 nm, h=50 nm, P=380 nm) using an FDTD program, which shows a resonance at 675 nm with a full width of 350 nm (between 500 nm and 850 nm) (see FIG. 16B, line labeled “NA”).
b) Using the FDTD program, simulate that the Fabry-Perot cavity (t₁=t₂=50 nm) exhibits the 2^{nd} and 3^{rd} ordered cavity modes at 802 nm and 553 nm, respectively (see FIG. 16A, and line labeled “Cavity” in FIG. 16B), when the cavity length (7) is 500 nm. The FDTD program can use Formula 1 or Formula 2, based on the user's input variables such as cavity thickness, RI of cavity material, deviation angle θ of the incident EM light, etc. These two modes are spontaneously overlapping with the localized surface plasmon resonance (LSPR) of the nanodisk array (with a center at 675 nm and a full width from 500 to 850 nm).
c) Therefore, the coupled structure (d₁=180 nm, d₂=0 nm, h=50 nm, P=380 nm, T=500 nm, t₁=t₂=50 nm) presents double resonances at 585 nm and 734 nm (FIG. 16B, line labeled “Coupled”). These double (coupled) resonances continuously boost signal enhancement for Raman spectroscopy at both the excitation and scattering wavelength, which contributes to its far better properties than normal singular resonance substrate.
d) With these optimized parameters, a double-resonance SERS structure with expected properties can be fabricated.

### Example 2

a) First, simulate the LSPR mode of the nano ring array (d₁=180 nm, d₂=100 nm, h=50 nm, P=380 nm) with the FDTD program, which shows a resonance at 826 nm with a full width of 400 nm (between 650 nm and 1050 nm) (see FIGS. 16C and 16E, and line labeled “NA” in FIG. 16D).
b) Using the FDTD program, simulate that the Fabry-Perot cavity (t₁=t₂=50 nm) exhibits the 2^{nd} and 3^{rd} ordered cavity modes at 1011 nm and 685 nm, respectively (see FIG. 16A, and line labeled “Cavity” in FIG. 16D), when the cavity length (7) is 650 nm. These two modes are spontaneously overlapping with the localized surface plasmon resonance (LSPR) of the nano ring array (with a center at 826 nm and a full width from 650 to 1050 nm).
c) The coupled structure (d₁=180 nm, d₂=100 nm, h=50 nm, P=380 nm, T=650 nm, t₁=t₂=50 nm) presents double resonances at 734 nm and 915 nm (FIG. 16D, line labeled “Coupled”).
d) With these optimized parameters, double-resonance SERS substrate with expected properties can be fabricated.

### Example 3

a) First, simulate the LSPR mode of the nanoring array (d₁=180 nm, d₂=100 nm, h=50 nm, P=380 nm) with the FDTD program, which shows a resonance at 826 nm with a full width of 400 nm (between 650 nm and 1050 nm) (see FIGS. 16C and 16E, and line labeled “NA” in FIG. 16F).
b) Using the FDTD program, simulate that the Fabry-Perot cavity (t₁=t₂=50 nm) exhibits the 4^{th} and 5^{th} ordered cavity modes at 907 nm and 729 nm, respectively (see FIG. 16A, and line labeled “Cavity” in FIG. 16F), when the cavity length (7) is 1200 nm. These two modes are spontaneously overlapping with the localized surface plasmon resonance (LSPR) of the nano ring array (with a center at 826 nm and with a full width from 650 to 1050 nm).
c) The coupled structure (d₁=180 nm, d₂=100 nm, h=50 nm, P=380 nm, T=1200 nm, t₁=t₂=50 nm) presents double resonances at 754 nm and 874 nm (FIG. 16F, line labeled “Coupled”).
d) With these optimized parameters, double-resonance SERS substrate with expected properties can be fabricated.

### Example 4

### In this Example, the LSPR Mode Only Couples to One Cavity Mode, Therefore Only Forms a Single Enhanced Mode)

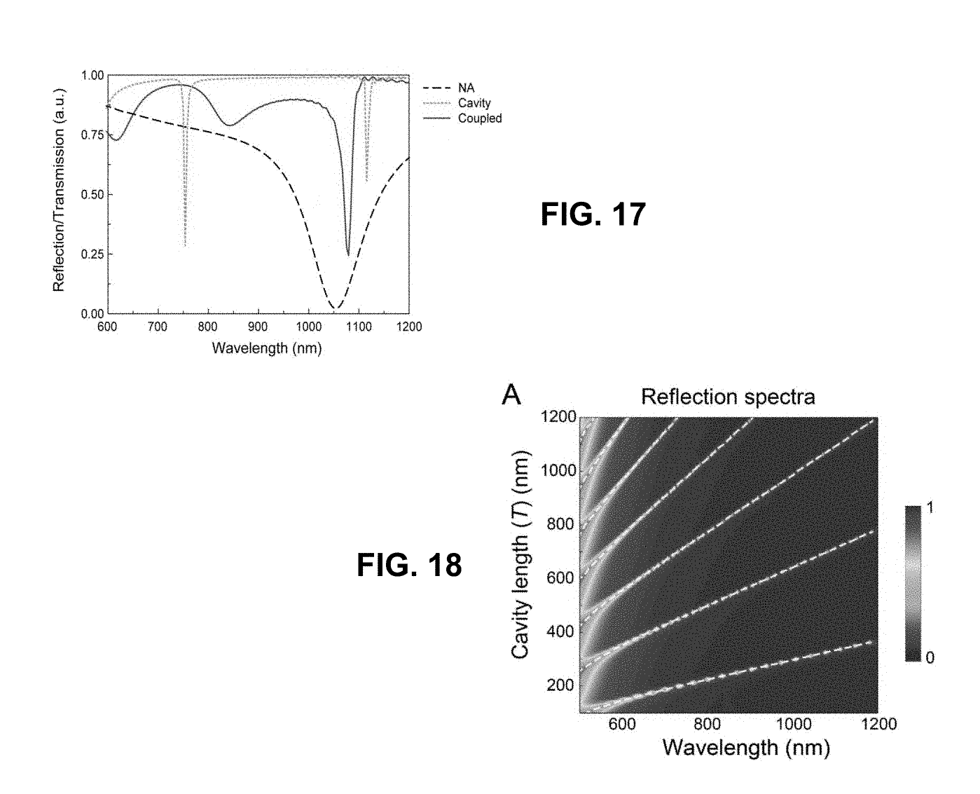

a) First, simulate the LSPR mode of the nanoring array (d₁=180 nm, d₂=140 nm, h=50 nm, P=380 nm) with the FDTD program, which shows a resonance at 1055 nm with a full width of 300 nm (between 900 nm and 1200 nm) (see FIG. 17, line labeled “NA”).
b) Using the FDTD program, simulate that the Fabry-Perot cavity (t₁=t₂=50 nm) exhibits the 2^{nd} and 3^{rd} ordered cavity modes at 1116 nm and 754 nm, respectively (see FIG. 16A, and line labeled “Cavity” in FIG. 17), when the cavity length (7) is 725 nm. Here, only the 2^{nd} ordered cavity mode is overlapping with the localized surface plasmon resonance (LSPR) of the nanodisk array (with a center at 1055 nm and with a full width from 900 to 1200 nm).
c) The coupled structure (d₁=180 nm, d₂=140 nm, h=50 nm, P=380 nm, T=725 nm, t₁=t₂=50 nm) presents only one apparent resonance at 1079 nm (FIG. 17, line labeled “Coupled”). As for weak coupling, the coupled 3^{rd} mode only shows as a weak dip.
d) With these parameters, only a single-resonance SERS substrate can be fabricated.

Disclosed herein are plasmonic metasurfaces of the pattern of a nano-ring array of structures and a metallic film spaced by a dielectric material for the generation of double resonances. The double resonances are realized by the strong coupling between the LSPR mode of the nanoring array and the cavity modes of the metal-insulator-metal (MIM) structure. Compared to the electric field around the nano-ring array and that in the cavity structure, the electric field enhancement at the double resonances of the metasurface is significantly boosted, therefore showing great potential for the double-resonance SERS application.

Since the double resonances originate from the overlapping and strong coupling between the narrow cavity modes and the broad LSPR mode, the investigation of the tunability of resonances can be simplified by separately looking into the gold cavity and the nano-ring array structures. When the Bragg principle is met for gold cavity, different orders of cavity resonance modes can be roughly calculated as

$$2 π N \approx 2 π \frac{2 nT}{λ} \qquad ( 3 )$$

where n is the real part of the refractive index and T is the thickness of the dielectric spacer. The formula presents a linear relationship between the wavelength (A) and the cavity length (7). From this formula, one can predict the cavity length (7) for different orders of cavity resonances at specific wavelengths. As we know, gold metal has an electronic interband transition at around 500 nm, and therefore gold plasmonic nanostructures on the top layer always have LSPR modes above 500 nm. Since double resonances are realized by the coupling/overlapping of the LSPR mode of top nano-ring arrays and the cavity mode of the gold cavity, according to the formula (1) above, the minimum cavity length (T) can be estimated to be around 180 nm, when λ=500 nm, N=1, n=1.4 (for SiO2). Here, the minimum cavity length is dependent on the refractive index of the dielectric layer.

The reflection spectra of the gold cavity (t₁=t₂=50 nm) can be derived from the FDTD calculations by adjusting the cavity length (7) from 100 to 1200 nm (see FIG. 18). The cavity modes indicated by white dashed lines show a linear relationship with the wavelength, and show large wavelength tunability from 500 to 1200 nm. These simulations agree well with the results from Formula 1. These lines present different orders of the cavity mode: 1 to 7 from bottom to top. With increasing the cavity length, all cavity modes are red-shifted and higher ordered cavity modes appear. As mentioned above, the top-surface electric field enhancements of all cavity modes are rather weak with a maximum value below 1.

### Example 5

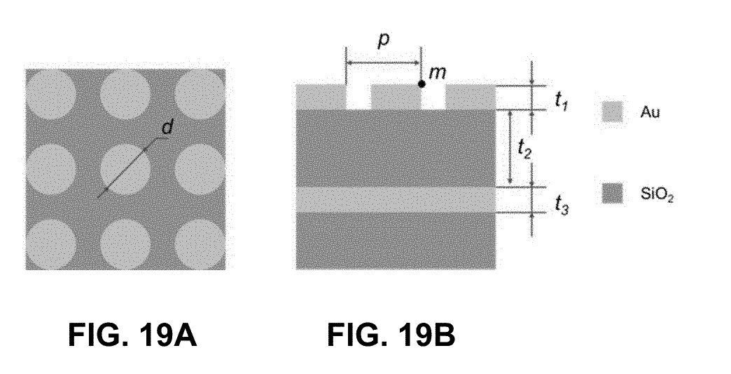

An additional nanodisk example is described below. FIGS. 19A and 19B illustrate the nanodisk structure and the Fabre-Perot structure on which it is formed. The height (t1) of the nanodisk array is 40 nm, the thickness (t2) of the SiO2 spacer is 23 nm and the thickness (t3) of bottom Au film is 100 nm. The diameter (d) and the period (p) are main parameters for the Au disk-SiO2-Au film structure. The electric field enhancement spectra are recorded at the point m (in the top right edge, see panel B). The double resonance is contributed by the localized surface plasmon resonance (LSPR) of the Au nanodisks and the surface propagating polariton (SPP) of the Au film. The controllable tunability of double resonances can be realized by modifying the diameter (d) and period (p) of the Au nanodisk array.

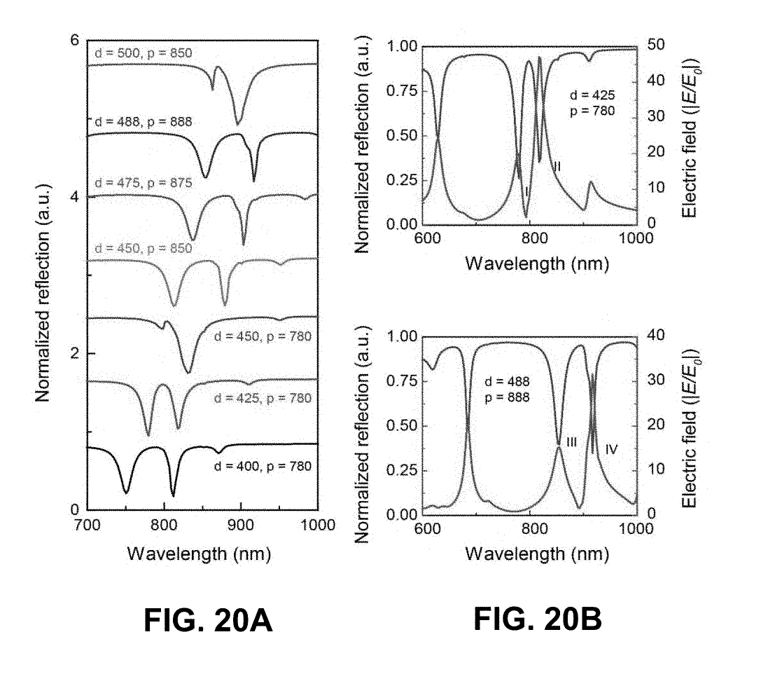

The wavelength of the LSPR of Au nanodisk array is determined by the diameter (d) of the disk and the SPP is tuned by the period (p). Double resonances with ideal resonant wavelengths can be realized by choosing specific diameter and associated period. In FIG. 20A, there are a series of structures with different d and p, showing double resonances (double dips) at variable wavelengths in the reflection spectra. Aiming at the double resonances at 785/830+/−15 nm or 850/925+/−15 nm, by tuning d and p, the goal of two Au disk-SiO2-Au film structures is achieved. Their corresponding reflection spectra (upper line) and simulated electric field enhancement spectra (lower line) at the point m are shown in FIG. 20B.

A first structure (see FIG. 20B) top, t1=40 nm, t2=23 nm, t3=100 nm, d=425 nm, p=780 nm) exhibits double resonances at 780 and 817 nm with the electric field enhancement factors (|E/E0|) of 20 and 47 times, respectively. Therefore, their SERS enhancement factors (|E/E0|4) are 1.6×10⁵ (780 nm) and 4.8×10⁶ (817 nm), respectively. A second structure (see FIG. 20B bottom, t1=40 nm, t2=23 nm, t3=100 nm, d=488 nm, p=888 nm) exhibits double resonances at 855 and 916 nm with the electric field enhancement factors (|E/E0|) of 15 and 32 times, respectively. Therefore, their SERS enhancement factors (|E/E0|4) are 0.5×10⁵ (855 nm) and 1×10⁶ (916 nm), respectively.

The simulations were performed by employing the finite difference time domain (FDTD) method using the program of FDTD Solutions (version 8.11.337) (Lumerical Solutions Inc., Canada). The empirical dielectric functions of Au and SiO₂ were fitted using Lumerical's multi-coefficient model (MCM). The simulation mesh size was set as 2 or 3 nm and the whole simulation environment is assumed to be air with dielectric constant of 1.

### Example 6

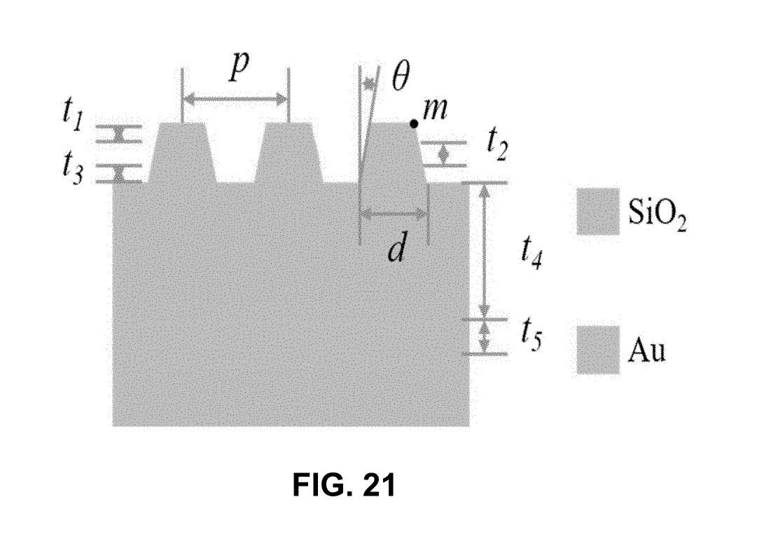

An additional nanoburger structure example is described below. FIG. 21 shows a side view of the nanoburger-SiO2-Au film structure, with the nano structure comprising a dielectric layer between two Au metal layers (nanoburger), formed on a Fabre-Perot structure. The diameter (d) is 120 nm, the height of nanoburger's top (t1) and bottom (t3) Au layer are 30 nm, the periodicity (p) of the nanoburger array is 300 nm and the thickness (t5) of the bottom Au film is 50 nm. The thickness (t2) of nanoburger's dielectric layer and cavity length (t4) are main parameters of the nanoburger-SiO2-Au film structure. The electric field enhancement spectra are recorded at the point m (at the top edge of nanoburger).

The resonance wavelength of the nanoburger-SiO₂—Au film structure (d=120 nm, p=300 nm, θ=0°, t₁=t₃=30 nm, t₂=15 nm and t₅=50 nm) can be tuned by cavity lengths (t₄) in the range of 400 nm to 1200 nm. Reflection spectra of the structures with different cavity lengths in this range are selectively presented with a step of 200 nm (Error! Reference source not found. 2A). From these spectra, it can be found that the multi-resonances are highly tunable from the visible to near-infrared optical range. The corresponding electric field enhancement at the point m has been plotted when the cavity length is 850 and 1150 nm.

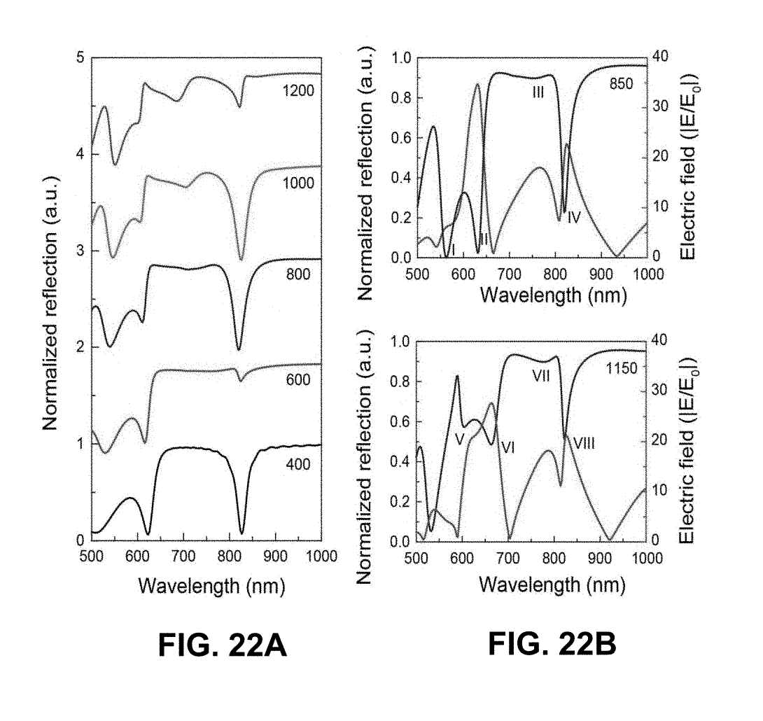

Such a structure (see FIG. 22B top) with d=120 nm, p=300 nm, θ=0°, t₁=t₃=30 nm, t₂=15 nm, t₄=850 nm and t₅=50 nm) shows multi-resonances at 563, 631, 754 and 819 nm with the electric field enhancement factors (|E/E₀|) of 6, 35, 18 and 20 times, respectively. Therefore, their SERS enhancement factors (|E/E₀|⁴) are 1.3×10³ (563 nm), 1.5×10⁶ (631 nm), 1.0×10⁵ (754 nm) and 1.6×10⁵ (819 nm), respectively. According to the electric field map, the enhancement factor may be much larger since the hot spot is not at m.

Such a structure (see FIG. 22B bottom) with d=120 nm, p=300 nm, θ=0°, t₁=t₃=30 nm, t₂=15 nm, t₄=1150 nm and t₅=50 nm) shows the multi-resonances at 603, 663, 776 and 822 nm with the electric field enhancement factors (|E/E₀|) of 13, 28, 18 and 19 times, respectively. Therefore, their SERS enhancement factors (|E/E₀|⁴) are 2.9×10⁴ (603 nm), 6.1×10⁵ (663 nm), 1.0×10⁵ (776 nm) and 1.3×10⁵ (822 nm), respectively.

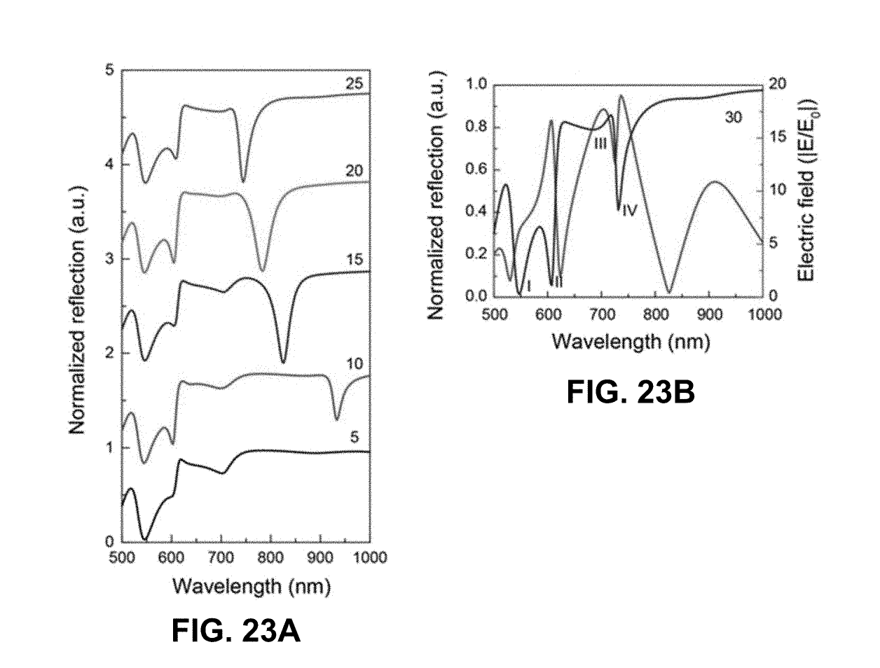

The dependence on the nanoburger's dielectric layer is now described. The thickness of the nanoburger's dielectric layer of the nanoburger-SiO₂—Au film structures (d=120 nm, p=300 nm, θ=0°, t₁=t₃=30 nm, t₄=1000 nm and t₅=50 nm) has been tailored in the range of 5 to 25 nm. Reflection spectra of the structures with variant burger's dielectric layer thickness in this range are selectively presented with a step of 5 nm (FIG. 23A). The rightest resonance is highly tunable, which is tailored from over 1000 nm to about 700 nm when the dielectric layer thickness changed from 5 nm to 25 nm. The electric field enhancement at the point m has been plotted when the dielectric layer thickness is 30 nm.

Such a structure (with d=120 nm, p=300 nm, θ=0°, t₁=t₃=30 nm, t₂=30 nm, t₄=1000 nm and t₅=50 nm) (see FIG. 23B) shows multi-resonances at 548, 608, 683 and 731 nm with the electric field enhancement factors (|E/E₀|) of 6, 17, 16 and 17 times, respectively. Therefore, their SERS enhancement factors (|E/E₀|⁴) are 1.3×10³ (548 nm), 8.4×10⁴ (608 nm), 6.6×10⁴ (683 nm) and 8.4×10⁴ (731 nm), respectively.

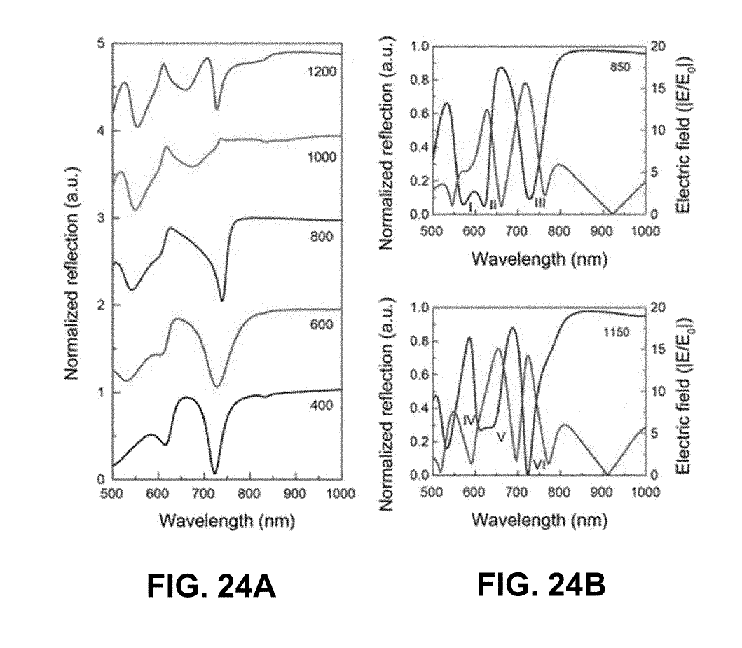

The dependence on the nanoburger's cavity length (truncated cone) is now described. Due to the self-shadowing effect during metal-evaporation the nanostructures are shaped into truncated cones, in other words the cone angle θ is not 0°. The resonance wavelength of the nanoburger-SiO₂—Au film structure (d=120 nm, p=300 nm, θ=20°, t₁=t₃=30 nm, t₂=15 nm and t₅=50 nm) can be tuned by cavity lengths (t₄) in the range of 400 nm to 1200 nm. Reflection spectra of the structures with different cavity lengths in this range are selectively presented with a step of 200 nm (See FIG. 24A). From these spectra, it can be found that multi-resonances are highly tunable from the visible to near-infrared optical range. The corresponding electric field enhancement at the point m has been plotted when the cavity length is 850 and 1150 nm.

Such as structure (see FIG. 24 Error! Reference source not found. B top), with d=120 nm, p=300 nm, θ=20°, t₁=t₃=30 nm, t₂=15 nm, t₁=850 nm and t₅=50 nm, shows multi-resonances at 573, 620 and 726 nm with the electric field enhancement factors (|E/E₀|) of 5, 12 and 15 times, respectively. Therefore, their SERS enhancement factors (|E/E₀|⁴) are 6.3×10² (573 nm), 2.1×10⁴ (620 nm) and 5.1×10⁴ (726 nm), respectively.

Such a structure (see FIG. 24B bottom) with d=120 nm, p=300 nm, θ=20°, t₁=t₃=30 nm, t₂=15 nm, t₄=1150 nm and t₅=50 nm) shows the multi-resonances at 613, 636 and 724 nm with the electric field enhancement factors (|E/E₀|) of 8, 12 and 14 times, respectively. Therefore, their SERS enhancement factors (|E/E₀|⁴) are 4.1×10³ (613 nm), 2.1×10⁴ (636 nm) and 3.8×10⁴ (724 nm), respectively.

The above demonstrates that the nanoburger-SiO₂—Au film structures show highly tunable multi-resonances by tuning the dimensional parameters such as the cavity length (t₄) and the thickness of nanoburger's dielectric layer (t₂) in terms of the wavelength, separation distance, and the electric field enhancement.

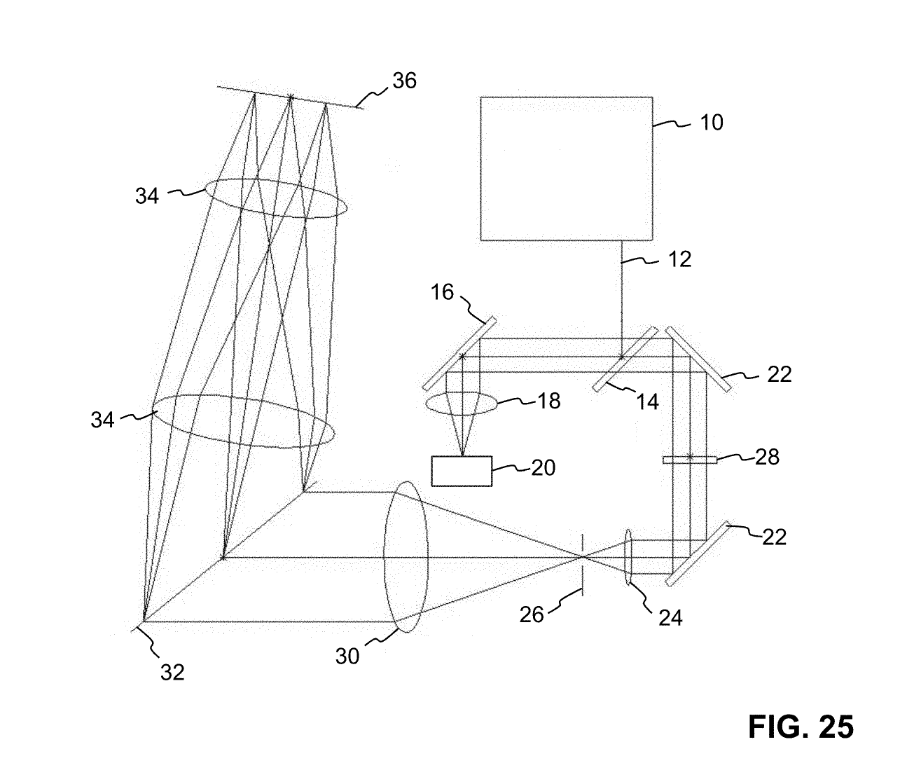

FIG. 25 illustrates an exemplary hardware implementation. A Dual Laser module 10 generates a light beam 12 that is reflected by the dichroic mirror 14, scanned by a 2D scanning mirror 16, and focused by a scanning lens 18 onto the chip 20 having SERS structure 100 formed thereon and exposed to a sample to be tested. Raman light from the chip 20 is collimated by the scanning lens 18, returned to the same path by the 2D scanning mirror 16, then passes through the dichroic mirror 14, reflected by mirrors 22 to fold the beam path in order to reduce the footprint, and focused by the tube lens 24 into the slit 26 of the spectrometer. LP filter 28 is used to clean the Raman light. Raman light enters into the spectrometer, collimated by the collimating lens group 30, dispersed by a grating 32, and then focused by the focus lens group 34 onto the CCD sensor 36. The scanning lens 16 can move along the optical axis to create the best imaging of the laser and collimating of the Raman light.

It is to be understood that the present invention is not limited to the embodiment(s) described above and illustrated herein, but encompasses any and all variations falling within the scope of any claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Further, as is apparent from the claims and specification, not all method steps need be performed in the exact order illustrated or claimed. Single layers of material could be formed as multiple layers of such or similar materials, and vice versa. Lastly, the terms “forming” and “formed” as used herein shall include material deposition, material growth, or any other technique in providing the material as disclosed or claimed.

It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements there between, as well as forming the element indirectly on the substrate with one or more intermediate materials/elements there between.

What is claimed is:

1. A spectroscopy structure, comprising:
a substrate;
a conductive layer formed on the substrate;
a dielectric layer formed on the conductive layer, wherein the dielectric layer has a first thickness;
spaced apart conductive structures formed on the dielectric layer having a periodicity, wherein each of the conductive structures has a second thickness and a shape that defines a localized surface plasmonic resonance (LSPR) frequency mode having a width;
wherein the dielectric layer defines two Fabry-Perot frequency modes that overlap within the width of the LSPR frequency mode.

2. The spectroscopy structure of claim 1, wherein the spaced apart conductive structures have one or more of the following shapes: round disk, triangular disk, quadrangular disk, cylinder, round ring, triangular ring, quadrangular ring, pentagonal ring and sphere.

3. The spectroscopy structure of claim 1, wherein the substrate is formed of at least one of metal, polymeric material, glass, silicon, silica, alumina and quartz.

4. The spectroscopy structure of claim 1, wherein the conductive layer is formed of one or more of the following materials: gold, silver, copper, aluminum, platinum, nickel, sodium, potassium lithium, titanium, chromium, cadmium, palladium and gallium.

5. The spectroscopy structure of claim 4, wherein the conductive layer is a continuous layer.

6. The spectroscopy structure of claim 1, wherein the dielectric layer is formed of one or more of the following materials: silica, glass, quartz, Al₂O₃, polymer and Si₃N₄.

7. The spectroscopy structure of claim 6, wherein the dielectric layer is a continuous layer.

8. The spectroscopy structure of claim 1, wherein the conductive structures are formed of one or more of the following materials: gold, silver, copper, aluminum, platinum, nickel, sodium, potassium, lithium, titanium, chromium, cadmium, palladium and gallium.

9. The spectroscopy structure of claim 1, further comprising:
an adhesion layer disposed between the substrate and the conductive layer, wherein the adhesion layer is formed of one or more of the following materials: silane, Cr and Ti.

10. The spectroscopy structure of claim 1, further comprising:
an adhesion layer disposed between the dielectric layer and the conductive structures, wherein the adhesion layer is formed of one or more of the following materials: silane, Cr and Ti.

11. The spectroscopy structure of claim 1, wherein the two Fabry-Perot frequency modes are defined by 2 nT/N, where n is a real part of a refractive index of the dielectric layer, T is a thickness of the dielectric layer, and N is an order of the cavity mode
